(19) United States
(12) Patent Application Publication
(10) Pub. No.: US 2005/0015672 A1
(43) Pub. Date: Jan. 20, 2005

(54) Identifying affected program threads and enabling error containment and recovery

(76) Inventor: Koichi Yamada, Los Gatos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/607,158

(22) Filed: Jun. 25, 2003

(51) Int. Cl. H02H 3/05

(52) U.S. Cl. 714/38

(57) ABSTRACT

Identification of an affected application program thread to enable error containment and recovery is described. According to one embodiment, an operating system receives an indication of a hardware error associated with an application program thread. The operating system determines the application program thread to be in a user operation mode and terminates the application program.

### TECHNICAL FIELD

Embodiments of the invention relate to the field of computer processing and, more specifically, to the identification and handling of affected application program threads during computer processing.

### BACKGROUND

Hardware error detection, containment, and recovery are critical elements of a highly reliable computing system. Precise error reporting is very difficult or very expensive for a computer system to implement because hardware errors are typically reported asynchronously to the program execution. This asynchronous nature of the error reporting mechanism from the computer system makes it very difficult for the operating system (“OS”) to implement reliable recovery methods.

In a particular instance, errors include data corruptions. Data corruptions occur during data transfers and while data is stored in the memory or cache. For example, in some hardware implementations data corruptions are detected though 2xECC logic or data poisoning. These data errors may be propagated and consumed during program execution, causing an operating system to initiate a shutdown of the entire computer system.

A hardware error being propagated means that the error has been made in an external storage (e.g., memory or hard disk). Therefore, error containment has failed, and the data is corrupted, and the system integrity is compromised.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary computer system according to one embodiment of the invention;

FIG. 2 illustrates a conceptual view of a software system on the computer system according to one embodiment of the invention; and

FIG. 3 illustrates one embodiment of a method to terminate an affected application thread.

### DETAILED DESCRIPTION

In the following description numerous specific details are set forth. However, it is understood that embodiments of the invention may be practiced without these specific details. In other instances, well-known circuits, structures, and techniques have not been shown in detail in order not to obscure the understanding of this description.

Identification of an affected application program thread to enable error containment and recovery is described. In a reliable computing implementation, hardware errors should be reported before the consumption of the errors. This guarantees the containment of the errors and prevents system-wide error propagations. However, the error containment itself is not good enough to enable the error recovery unless the operating system can identify the affected program thread. Typically, identifying the affected program threads is very difficult due to the asynchronous nature of the error reporting mechanism.

In one embodiment of the invention, an operating system receives machine error information of the operation mode of an offending application program thread, and terminates an affected application program thread if the thread is in the user operation mode, as will be described. An offending application program thread is the thread that issued an instruction causing a machine check abort (“MCA” or hardware error signal) from a hardware device. An affected application program thread is the thread in whose context the MCA was reported. As will be described, the operating system distinguishes when to terminate the affected thread and let the other application programs continue, or when to shut down the entire software system. Furthermore, in one embodiment, the operating system ensures an MCA is received during operating system execution in the kernel operation mode and is not misconstrued as an error during application execution in the user operation mode, as will be described.

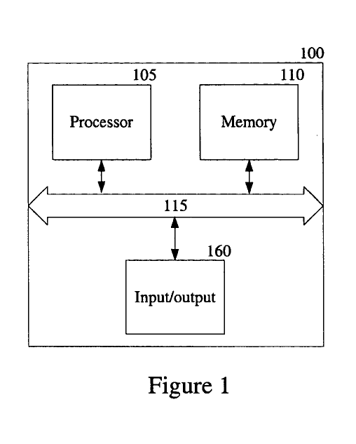

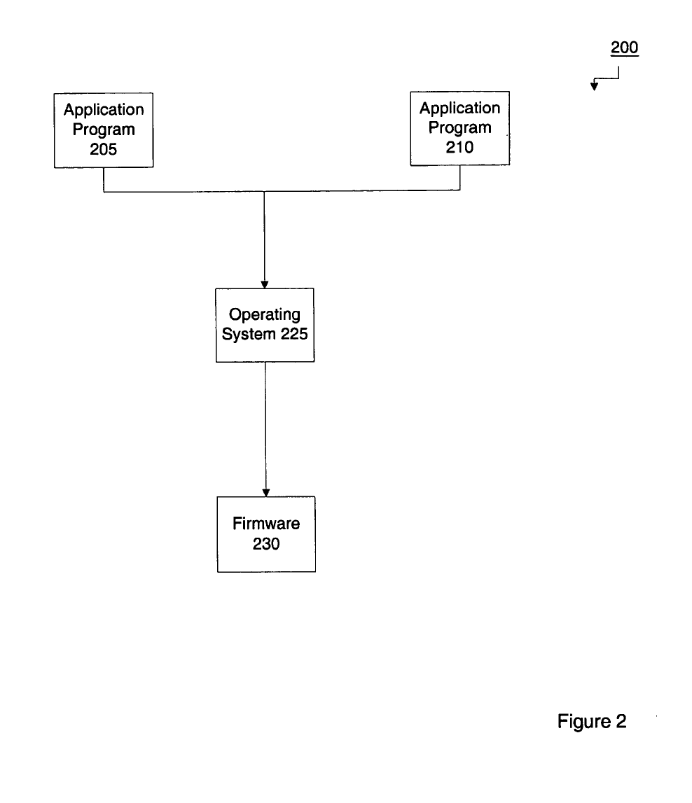

A brief overview of a typical hardware and software environment in which embodiments of the invention may be practiced is illustrated in FIG. 1 and FIG. 2. FIG. 1 shows a block diagram illustrating an exemplary computer system 100 according to an embodiment of the invention. The computer system 100 includes a processor 105 coupled to a memory 110 by a bus 115. In addition, a number of user input/output 160, such as a keyboard and a display, may also be coupled to the bus 115, but are not necessary parts of embodiments of the invention. The processor 105 represents a central processing unit of any type of architecture, such as a CISC, RISC, VLIW, or hybrid architecture. In addition, the processor 105 could be implemented on one or more chips.

The bus 115 represents one or more busses (e.g., PCI, ISA, X-Bus, EISA, VESA, etc.) and bridges (also termed as bus controllers). While this embodiment is described in relation to a single processor computer system, embodiments of the invention could be implemented in a multi-processor computer system.

FIG. 1 additionally illustrates that the processor 105 includes an execution unit (not shown), an internal bus (not shown), an instruction pointer register (not shown), a suspended instruction pointer register (not shown), a status register (not shown), and a suspended status register (not shown). Of course, processor 105 contains additional circuitry, which is not necessary to understanding the description.

The internal bus couples several of the elements of the processor 105 together as shown. The execution unit is used for executing instructions. The instruction pointer register is used for storing an address of an instruction currently being executed by the execution unit. The status register is used for storing status information concerning the process currently executing on the execution unit. The contents of the instruction pointer register and the status register make up the execution of an environment of a process (e.g., an application program) currently executing on the processor 105. The suspended instruction pointer register and suspended status register are used for temporarily storing the execution environment of a process (e.g., an application program) whose execution is suspended in response to an event (e.g., a context switch). However, alternative embodiments could use any number of techniques for temporarily storing the execution environment of the suspended process.

FIG. 2 illustrates a conceptual view of a software system 200 on the computer system 100 according to one embodiment of the invention. The software system 200 includes an application program 205, an application program 210, an operating system 225, and firmware 230.

The application programs 205 and 210 are user software programs that interact with the operating system 225 to perform a specific function directly for a user.

The operating system 225 is low-level software that handles the interface to peripheral hardware devices, scheduling of tasks, allocation of storage, and presents a default interface to the user when no application program is running. In a multitasking operating system where multiple application programs may be performed at the same time, the operating system determines which application program should run in what order and how much time should be allowed for each application program to run before swapping processes.

Examples of operating systems include 386BSD, AIX, AOS, Amoeba, Angel, Artemis microkernel, BeOS, Brazil, COS, CP/M, CTSS, Chorus, DACNOS, DOSEXEC 2, GCOS, GEORGE 3, GEOS, ITS, KAOS, Linux, LynxOS, MPV, MS-DOS, MVS, Mach, Macintosh operating system, MINIX, Multics, Multipop-68, Novell NetWare, OS-9, OS/2, Pick, Plan 9, QNX, RISC OS, STING, System V, System/360, TOPS-10, TOPS-20, TRUSIX, TWENEX, TYMCOM-X, Thoth, Unix, VM/CMS, VMS, VRTX, VSTa, VxWorks, WAITS, Windows 3.1, Windows 95, Windows 98, and Windows NT, among other examples well known to those of ordinary skill in the art.

One distinction between application programs (205, 210) and the operating system 225 is that application programs run in a user operation mode (or “non-privileged mode”), while operating systems run in a kernel operation mode (or “privileged mode”). In the kernel operation mode, the operating system 225 has access to and coordinates among an application program and various hardware devices, input/output 160, bus 115, and memory 110. In the user operation mode, the kernel places restrictions on the specific application program activity.

The firmware 230 is embedded software (e.g., read-only memory, programmable read-only memory, etc.) stored within a hardware device. For example, the firmware 230 may be installed in a hardware device, such as memory 110, processor 105, and bus 115 and may be responsible for detecting hardware errors on the memory 110, processor 105 and/or bus 115, respectively. Most hardware errors are corrected by either hardware error correction logic or the firmware (230) on each hardware device. However, to further enhance system availability and reliability, a hardware error that cannot be corrected by firmware and/or may have been propagated through another location, is handed off to the operating system 225 for recovery. For example, application program 205 may have requested a load of data from the memory device 110, which may have included a data error. When this occurs, the operating system typically causes the computer system to shutdown, in order to prevent the propagation of the error.

Another example of when a hardware error is propagated is during a context switch. Context switching occurs when a multitasking operating system stops running one process (e.g., application program 205) and starts running another (e.g., application program 210). Many operating systems implement concurrency by maintaining separate environments or “contexts” for each process. In order to present the user with an impression of parallism, and to allow processes to respond quickly to external events, many systems will context switch tens or hundreds of times per second. The amount of separation between processes, and the amount of information in a context, depends on the operating system, but generally the operating system should prevent processes interfering with each other, e.g. by modifying each other's memory.

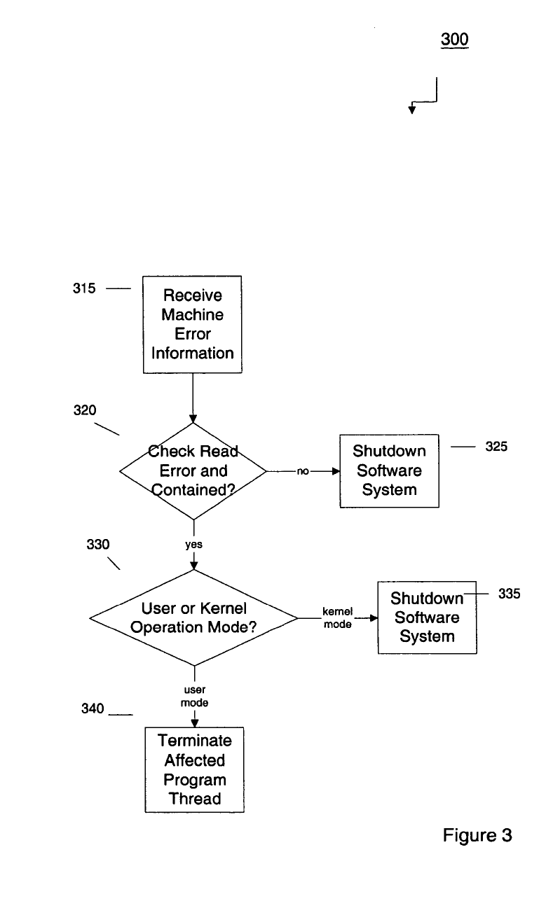

FIG. 3 illustrates one embodiment of a method (300) to terminate an affected application program thread. The following method describes how the operating system 225 may identify and terminate the affected application program thread.

At block 315, the operating system 225 receives machine error information of an affected application program from a hardware device. The machine error information may include information of whether the error on the hardware device was successfully contained, information of whether the error on the hardware device occurred on a memory read, information of the operation mode (user or kernel) of the interrupted application program thread, and/or information of the poisoned data address. For example, the machine error information may be provided from the processor 105, the bus 115, or the memory 110. It should be understood that the term “poisoned data” is a hardware mechanism used in the Intel platform (of Intel Corporation of Santa Clara, Calif.) to indicate a portion of memory has been corrupted. Any read to that poisoned memory may generate an MCA and this is a way of containing the error. However, embodiments of the invention are not limited to the Intel platform, and one of ordinary skill in the art will recognize that embodiments of the invention may be used to perform similar methods on alternative platforms.

In one embodiment, received machine error information, due to reading poisoned data, will be signaled before the use of the load. For example, in the code sequence below:

| | |
|---|---|
| LabelA: Ld8 r15 = [r16]; | |
| LabelB: Mov r17 = r18; | |
| LabelC: Add r19 = r20, r21; | |
| . . . | |
| . . . | |
| LabelD: Mov r22 = r15 | // an MCA is signaled |
| | // before this |
| | // instruction |

If the data pointed to by general register 16 is poisoned, an MCA will surface at any point during the interval from instruction LabelA through instruction LabelD before the data is consumed at instruction LabelD.

In other examples, the hardware device may report a multi-bit error in data loaded from memory as local MCAs. Memory reads may occur due to instruction fetches or data loads. Data loads may also occur during stores if the processor uses write-allocate caching.

At block 320, the operating system 225 checks the machine error information to determine if a memory read error has occurred and whether the error was successfully contained. When a memory read error occurs and the hardware errors are successfully contained, the memory read error is assumed to have surfaced before the register consumptions (e.g., before LabelD above). Therefore, by checking the machine error information, the operating system assumes the errors are successfully contained within the affected application program thread. In one embodiment, whether the error is successfully contained within the affected thread is known because the context switch code has the fencing operation (consuming all the registers) before switching to another thread.

If a memory read error has occurred and was successfully contained, control passes to block 330. If a memory read error has occurred and was not successfully contained, control passes to block 325. At block 325, the operating system initiates a process to shutdown the software system 200. The operating system initiates the shutdown in order to minimize further damage (e.g., avoid further propagation of the error).

At block 330, the operating system checks the machine error information for the operation mode of the affected application program thread. For example, the machine error information may contain an interrupted processor status register value and the privilege level of the interrupted context is a field within this register.

The operating system 225 can use the operation mode of the interrupted context to decide whether an application or the kernel consumed the data. When the operation mode of the application program thread 205 is in the user operation mode, control passes to block 340.

When the operation mode of the application program thread of the application program 205 is in the kernel operation mode, control passes block 335. At block 335, the operating system 225 initiates a shutdown of the entire software system 200. This is because it is difficult for the operating system to safely terminate the kernel thread, as the kernel execution has system-wide impact.

At block 340, the operating system terminates the affected application program thread and recovers from the error. Since the affected application thread occurred while in the user operation mode, the operating system 225 may conclude that the affected thread was an application and terminate it. The operating system 225 carries the current thread pointer in its data structures, which is used to terminate the thread.

In one embodiment, the operating system determines the appropriate recovery actions using the physical address of the bad memory location. The page with poisoned memory may be private to the application, shared by multiple applications, or shared between the application and the operating system. If the operating system maintains data structures indicating the shared information on a physical page basis, it could terminate all the applications sharing the poisoned memory page. Whether or not all such applications need to be terminated is an operating system policy decision.

It should be appreciated that, by identifying the operation mode of the affected thread, the operating system 225 avoids always terminating the entire system after receiving a hardware data error, as described above. This should not be confused with the termination of an application program upon an occurrence of an application software error (e.g., caused by a programming error or software bug) within the application software.

It should also be appreciated that process 300 takes advantage of most operating system designs in which it is difficult to terminate the threads while they are operating in the kernel mode, but still makes it possible to terminate the program threads safely while they are operating in the user mode.

In addition, in one embodiment, the operating system will confirm that all the registers have been consumed when the operating system 225 performs a context switch before performing process 300. If all the registers are not consumed before switching the application programs, an error may be propagated into an incoming thread and a containment of the error in the same thread may fail. Therefore, the operating system 225 initiates a shutdown of the entire software system. If all the registers are consumed before switching to the application programs, the process 300 is initiated.

It should be understood that in some software systems, the operating systems might not maintain a database of physical to virtual mappings because of the difficulty in keeping such a database current. If such a database is maintained, the operating system data structure design must allow for memory size changes due to hot-plug addition or removal of memory. Also, appropriate synchronization steps, well known to those of ordinary skill in the art, could be followed in a multiple processor (“MP”) system configuration during updates to the operating system data structure. The operating system may terminate application programs when they access the portion of memory that is poisoned. If application programs don't refer to the poisoned cache line of memory, they may execute to normal completion.

For both approaches, the operating system needs to keep track of the pages that have poisoned memory. When there are no application programs referring to the page with poisoned memory, the operating system may clear the poisoned page and recycle the page for use by other application programs.

For example, once the operating system has terminated the application programs that had a mapping to the poisoned memory page, it can take steps to recycle the page for use by other application programs. If the operating system were to attempt a store of zeroes to the problem memory area, there will be a read of the cache line from poisoned memory, resulting in another MCA on processors with write-allocate caches. One method is to first change the memory attribute of the problem page from writeback to uncacheable and then storing zeroes to the poisoned memory area. Poisoned cache lines that are modified are flushed to memory; however, the flush generates only a Corrected Machine Check Interrupt (“CMCI”) and does not result in another MCA.

It should be understood that alternative platforms may have alternative techniques to scrub poisoned cache lines and the invention is not limited to only those disclosed herein. In addition, in an alternative embodiment, the operating system may choose not to recycle the page and similarly place the page onto a bad page list well known to those of ordinary skill in the art.

In one embodiment, the operating system must allow for the fact that error checking and correction (“ECC”) methods differ across platforms. For example, in a system based on the Intel Itanium 2 processor and Intel E8870 chipset, from Intel Corporation of Santa Clara, Calif., the memory controller on the E8870 chipset uses chipkill ECC (12 check bits cover 32 bytes), while the Itanium 2 processor system bus uses a different number of check bits and covered bytes. An uncorrectable memory error may have a larger footprint than 8 bytes, whether the source of the error is a real multi-bit error or data poisoning. The operating system should clear the entire memory page that contains the poisoned memory location.

When the page has been cleared of poison, the operating system can revise its data structures for poisoned memory pages. Some operating system implementations may choose not to recycle such pages based on thresholding statistics. Such an indication may be provided in the message error information.

It should be appreciated that, in one embodiment, until the poisoned page is cleared, the operating system may avoid additional MCAs from arising from the poisoned memory page by marking the poisoned page as not eligible for 10 write. This would prevent that page from being written to backing store, which would generate another MCA. This step is unnecessary if the operating system or device driver can recover from MCAs during transfer of data from the poisoned memory page to the device.

It will be appreciated that more or fewer processes may be incorporated into the method illustrated in FIG. 3 without departing from the scope of the invention and that no particular order is implied by the arrangement of blocks shown and described herein. It further will be appreciated that the method described in conjunction with FIG. 3 may be embodied in machine-accessible instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-accessible medium having stored thereon instructions, which may be used to program a computer (or other electronic devices) to perform the methods. For the purposes of this specification, the terms “machine-accessible medium” shall be taken to include any medium that is capable of storing or encoding a sequence of instructions for execution by the machine and that cause the machine to perform any one of the methodologies of the present invention. The term “machine-accessible medium” shall accordingly be taken to include, but not be limited to, solid-state memories, optical and magnetic disks and carrier wave signals. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result.

Thus, identification of an affected application program thread to enable error containment and recovery has been described. It should be appreciated that the method described takes advantage of the error containment premise and implements an effective and simple fencing method to identify the affected thread. This allows the operating system to recover from hardware errors by terminating the affected program thread without shutting down the entire system. This significantly increases the reliability and availability of a computer system. In addition, embodiments of the invention make error recovery possible by the operating system without investing in expensive hardware support of the precise error reporting. This allows the operating system to implement error identification and recovery without extensive operating system changes.

Although the description describes an offending thread and an affected thread, it should be understood that in an alternative embodiment a synchronous MCA reporting (e.g., by hardware) might be implemented so that the offending thread and the affected thread is always the same. The thread to which an MCA is reported is the affected thread.

While the invention has been described in terms of several embodiments, those skilled in the art will recognize that the invention is not limited to the embodiments described. The method and apparatus of the invention can be practiced with modification and alteration within the scope of the appended claims. The description is thus to be regarded as illustrative, instead of limiting, on the invention.

1. A method of terminating an affected application program thread, comprising:
receiving an indication of a hardware error associated with an application program thread;
determining the application program thread to be in a user operation mode; and
terminating the application program.

2. The method of claim 1, wherein the terminating the application program further comprises:
determining the hardware error is a memory read error, the memory read error being associated with the application program thread.

3. The method of claim 2, further comprising:
determining the memory read error is successfully contained.

4. The method of claim 3, further comprising:
receiving information of whether the memory read error is contained.

5. The method of claim 2, further comprising:
receiving information of whether the hardware error occurred on a memory read.

6. The method of claim 1, further comprising:
receiving information of a poisoned data address associated with the hardware error.

7. The method of claim 1, further comprising:
confirming one or more registers associated with the application program thread are consumed.

8. A system comprising:
a processor to perform an instruction from an operating system; and
a memory component to provide machine error information to the operating system, the machine error information to include an operation mode of the an affected application program, the operating system to terminate the affected application program thread upon determining the affected application program to be within a user operation mode.

9. The system of claim 8, wherein the processor is to receive an instruction from the operating system to terminate the affected application program thread upon determining a memory read error has occurred.

10. The system of claim 9, wherein the processor is to receive an instruction from the operating system to terminate the affected application program thread upon determining the memory read error is contained.

11. The system of claim 9, wherein the operating system is to check the machine error information message to determine whether the memory read error occurred.

12. The system of claim 11, wherein the operating system is to check the machine error information message to determine whether the memory read error is contained.

13. A machine-accessible medium that provides instructions that, if executed by a machine, will cause the machine to perform operations comprising:
receiving an indication of a hardware error associated with an application program thread;
determining the application program thread to be in a user operation mode; and
terminating the application program.

14. The machine-accessible medium of claim 13, wherein the terminating the application program further comprises:
determining the hardware error is a memory read error, the memory read error being associated with the application program thread.

15. The machine-accessible medium of claim 14, further comprising:
determining the memory read error is successfully contained.

16. The machine-accessible medium of claim 15, further comprising:
receiving information of whether the memory read error is contained.

17. The machine-accessible medium of claim 14, further comprising:
receiving information of whether the hardware error occurred on a memory read.

18. The machine-accessible medium of claim 13, further comprising:
receiving information of a poisoned data address associated with the hardware error.

19. The machine-accessible medium of claim 13, further comprising:
confirming one or more registers associated with the application program thread are consumed.

20. A system comprising:
a means for receiving an indication of a hardware error associated with an application program thread;
a means for determining the application program thread to be in a user operation mode; and
a means for terminating the application program.

21. The system of claim 20, wherein the means for terminating the application program further comprises:
a means for determining the hardware error is a memory read error, the memory read error being associated with the application program thread.

22. The system of claim 21, further comprising:
a means for determining the memory read error is successfully contained.

23. The system of claim 22, further comprising:
a means for receiving information of whether the memory read error is contained.

24. The system of claim 23, further comprising:
a means for receiving information of whether the hardware error occurred on a memory read.

25. The system of claim 20, further comprising:
a means for receiving information of a poisoned data address associated with the hardware error.

26. The system of claim 20, further comprising:
a means for confirming one or more registers associated with the application program thread are consumed.
